(19) United States
(12) Patent Application Publication
(10) Pub. No.: US 2014/0158390 A1
(43) Pub. Date: Jun. 12, 2014

(54) ELECTRIC TOOL

(71) Applicants: Hironori Mashiko, Ibaraki (JP); Nobuhiro Takano, Ibaraki (JP)

(72) Inventors: Hironori Mashiko, Ibaraki (JP); Nobuhiro Takano, Ibaraki (JP)

(73) Assignee: HITACHI KOKI CO., LTD., Tokyo (JP)

(21) Appl. No.: 14/233,644

(22) PCT Filed: Jul. 20, 2012
(86) PCT No.: PCT/JP2012/069058

§ 371 Date: Jan. 17, 2014

(30) Foreign Application Priority Data
Jul. 21, 2011 (JP) 2011-159909

(51) Int. Cl. B25B 21/02; B25B 23/147

(52) U.S. Cl. CPC B25B 21/02; B25B 23/1475
USPC 173/47; 173/217

(57) ABSTRACT

An electric tool including: a motor; a tip tool configured to be rotationally driven by the motor; and a control unit configured to control the rotation of the motor and including a microprocessor and a memory unit, wherein the memory unit is configured to store control information by learning a use state of the motor, and wherein the motor is configured to be driven according to the stored control information.

### TECHNICAL FIELD

Aspects of the invention relate to an electric tool for driving a tip tool using a motor, specifically to an electric tool which can realize drive control of the tip tool to be most suitable for an operator by using a learning function.

### BACKGROUND ART

An electric tool for driving a tip tool using a motor as a drive source is widely used. An impact tool is an example of such electric tool. The impact tool is a tool which, while driving a rotary impact mechanism using a drive source, applies a rotation force and a striking force to an anvil to intermittently transmit a rotational striking force to a tip tool, thereby executing a screwing operation or the like. Recently, as the drive source, there has been widely used a brushless DC motor. The brushless DC motor is, for example, a DC (direct current) motor with no brush (rectifying brush), which uses a coil (winding) on the stator side and a magnet (permanent magnet) on the rotor side and conducts electric power driven by an inverter circuit to a predetermined coil sequentially to thereby rotate a rotor. The inverter circuit is constituted of a large-capacity output transistor such as an FET (Field Effect Transistor) or an IGBT (Insulated Gate Bipolar Transistor) and is driven by a large current. The brushless DC motor, when compared with a brush DC motor, is preferable in torque characteristics and can fasten a screw, a bolt and the like to a work piece with a stronger force.

The electric tool using the brushless DC motor controls an inverter circuit using a microcomputer to realize various kinds of control such as motor continuous drive control and motor intermittent drive control. For example, JP-A-2011-31314 proposes an electric tool having a so called electronic clutch mechanism which monitors the increasing current of a motor according to a reaction force received from a tip tool and when the current reaches a predetermined current value, determines the end of a fastening operation and stops the rotation of the motor.

### SUMMARY OF INVENTION

### Technical Problem

In the above-described related-art electric tool, since an electric tool maker previously sets a control mode considered to be most suitable for an operator (user) before the electric tool is shipped from a factory, after the electric tool is shipped, it is substantially impossible to change the control mode. Therefore, it is impossible for the user to change the fastening control and the timing for switching a continuous drive mode to an intermittent drive mode in accordance with the demand of the user.

The invention is made in view of the above background and it is an object of the invention to provide an electric tool which can realize an optimum drive mode for every user.

Another object of the invention to provide an electric tool which can realize the optimum drive mode by learning a drive control which is most suitable for every user.

Another object of the invention to provide an electric tool in which a drive control condition can be changed in accordance with a demand of a user with a simple operation.

### Solution to Problem

The typical characteristics of the invention disclosed in the application are as follows.

In a first aspect, there is provided an electric tool including: a motor; a tip tool configured to be rotationally driven by the motor; and a control unit configured to control the rotation of the motor and including a microprocessor and a memory unit, wherein the memory unit is configured to store control information by learning a use state of the motor, and wherein the motor is configured to be driven according to the stored control information.

In a second aspect, there is provided an electric tool according to the first aspect, wherein the control information includes any one of a fastening time by the motor, a current limit value of the motor and a rotation number of the motor.

In a third aspect, there is provided an electric tool according to the second aspect, wherein the control information is a learning value which is obtained during a specific operation specified by an operator.

In a fourth aspect, there is provided an electric tool according to any one of the first to third aspects, wherein the electric tool is a striking tool including a hammer and an anvil, and wherein the control information is information for determining a timing for shifting from a continuous drive mode to an intermittent drive mode using the hammer and the anvil.

In a fifth aspect, there is provided an electric tool according to the fourth aspect, wherein the control information is a current value of the motor when switching the continuous drive mode to the intermittent drive mode.

In a sixth aspect, there is provided an electric tool according to any one of the first to fifth aspect, further including a sample mode switch for designating a start and an end of the specific operation.

In a seventh aspect there is provided an electric tool according to the sixth aspect, wherein the specific operation is executed for a plurality of times and a value calculated from a plurality of drive current values, which is obtained during the specific operation, is set as control information.

In an eighth aspect, there is provided an electric tool according to the seventh aspect, wherein the calculated value is an average of maximum values of the obtained drive current values.

In a ninth aspect, there is provided an electric tool according to any one of the first to eighth aspect, further including a reset function for canceling the control information stored in the memory unit and replacing the control information to control information which is set when the electric tool is shipped from a factory.

### Advantageous Effects of Invention

According to the first aspect, the control unit includes the memory unit, the memory unit is configured to store control information by learning a use state of the motor, and the motor is configured to be driven according to the stored control information. This can realize a control most suitable for the various fastening operation for every operator.

According to the second aspect, since the control information includes any one of the fastening time by the motor, the motor current limit value and the motor rotation number, such control information can be changed to the appropriate information in accordance with the use state of the user.

According to the third aspect, since the control information is a learning value obtained during a specific operation specified by the user, appropriate control information can be determined by several sampling operations.

According to the fourth aspect, since the control information is information that determines the timing for shifting from the continuous drive mode to the intermittent drive mode using a hammer and an anvil, a striking operation most suitable for the fastening operation can be realized.

According to the fifth aspect, since the control information is the current value of the motor when switching the continuous drive mode to the intermittent drive mode, the striking strength can be changed easily simply by changing the control information.

According to the sixth aspect, by providing a sample mode switch for specifying the start and end of a specific operation, the operator can execute the learning operation at arbitrary timing.

According to the seventh aspect, since the specific operation is executed for a plurality of times and a calculation value calculated based on drive current values obtained in the multiple-time specific operations is set as a switch current (control information), it is possible to provide an electric tool which can surely reproduce the control state intended by the operator.

According to the eighth aspect, since the calculated value is the average of the maximum values of the obtained drive current values, it is possible to set the appropriate control information coincident with a state intended by the user.

According to the ninth aspect, by providing a reset function which cancels the control information stored in the memory unit and returns it to the control information when the electric tool is shipped from a factory, even when the learned control information is in an unfavorable state, it can be returned easily to its initial state, thereby being able to realize an electric tool easy to use.

The above and other objects and new characteristics of the invention will be obvious from the following description of the specification and accompanying drawings.

### BRIEF DESCRIPTION OF DRAWINGS

FIG. 1 is a longitudinal section view of the entire structure of an electric tool 1 of an exemplary embodiment of the invention;

FIG. 2 is a side view of the electric tool 1 of the exemplary embodiment;

FIG. 3 is an exploded perspective view of a planetary carrier assembly 51 and an anvil 61 shown in FIG. 1, showing the shapes thereof,

FIG. 4 is a section view taken along the A-A arrow line in FIG. 1, showing the striking operations of hammers 52, 53 and the striking pawls 64, 65 of an anvil 61 while the movement of one-time rotation is shown in six stages;

FIG. 5 is a function block diagram of the drive control system of the motor 3 of the electric tool 1 of the exemplary embodiment;

FIG. 6 is a view of the states of the motor rotation numbers and hammer rotation angles when executing the drive control of the motor 3 of the electric tool 1 of the exemplary embodiment;

FIG. 7 is a graphical representation of the states of the respective parts in a learning operation according to the exemplary embodiment;

FIG. 8 is a flow chart of the learning procedures of the electric tool 1 of the exemplary embodiment; and

FIG. 9 is a graphical representation of an example of the value of a current flowing in the motor after end of the learning operation according to the exemplary embodiment.

### DESCRIPTION OF EMBODIMENT

### Embodiment 1

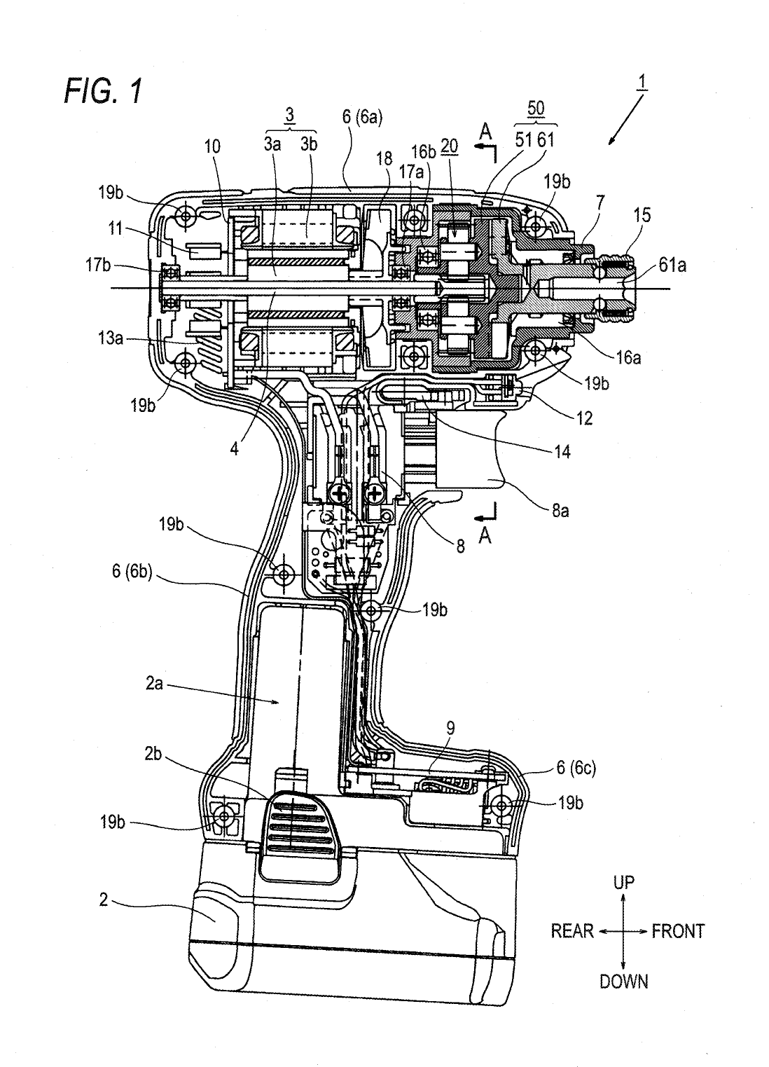

Hereinafter, exemplary embodiments of the invention will be described with reference to the accompanying drawings. In the following description, upper, lower, front and rear directions are those shown in FIG. 1.

FIG. 1 is a longitudinal section view of the entire structure of an electric tool 1 of an exemplary embodiment of the invention. The electric tool 1 drives a striking mechanism 50 by using a rechargeable battery pack 2 as a power source and a motor 3 as a drive source. By driving the striking mechanism 50, a rotation force and a striking force is applied to an anvil 61 serving as an output shaft to transmit a continuous rotation force or an intermittent striking force to a tip tool (not shown) such as a driver bit, thereby executing a screw fastening operation, a bolt fastening operation and the like.

The motor 3 is a brushless DC motor and is stored into a substantially tubular-shaped body portion 6a of a housing 6 having a substantially T-shaped side view in such a manner that the axial direction of its rotation shaft 4 coincides with a longitudinal direction of the motor 3. The housing 6 is constituted of right and left members which are substantially symmetric in shape and can be divided from each other, while the left and right members can be fixed together using a plurality of screws (not shown). Thus, one member (in this exemplary embodiment, left housing) of the dividable housing 6 has a plurality of screw bosses 19b, while the other (right housing) (not shown) has a plurality of screw holes. The rotation shaft 4 of the motor 3 is rotatably supported by a bearing 17b disposed on the rear end side of the body portion 6a and a bearing 17a disposed near the central portion thereof. Rear to the motor 3, there is provided an inverter board 10 with six switching elements 11 mounted thereon, while inverter control is executed using these switching elements 11 to thereby rotate the motor 3. At a position existing on the front side of the inverter board 10 and facing the permanent magnet of the rotor, there is mounted a rotation position detecting element (not shown) such as a Hall IC for detecting the position of the rotor.

The housing 6 includes a trigger operation portion 8a and a forward/reverse switching lever 14 in the upper portion of a handle portion 6b extending from the body portion 6a integrally therewith and substantially perpendicularly thereto, while a trigger switch 8 includes a trigger operation portion 8a energized by a spring (not shown) to project from the handle portion 6b. An LED 12 is held at a position existing downwardly of a hammer case 7 to be connected to the leading end side of the body portion 6a. The LED 12 is configured such that, when a bit serving as a tip tool (not shown) is mounted into a mounting hole 61a, it can illuminate near the front end of the bit. A control circuit board 9 including thereon a control circuit having a function to control the speed of the motor 3 according to the operation of the trigger operation portion 8a is stored into a battery hold portion 6c existing within and downwardly of the handle portion 6b. On a side portion of the control circuit board 9, there are disposed a plurality of switches (which will be discussed later) for setting the operation mode of the electric tool 1. Using the switches, a plurality of operation modes can be switched: for example, the operation mode can be switched to “drill mode (with no clutch mechanism)”, “drill mode (with clutch mechanism)”, or “impact mode”. In the “impact mode”, the strength of the striking torque may preferably be set such that it can be varied stepwise or continuously.

The battery pack 2 with a plurality of battery cells such as nickel hydrogen battery cells or lithium ion battery cells stored therein is removably mounted in the battery hold portion 6c of the housing 6 formed downwardly of the handle portion 6b. The battery pack 2 includes an extension portion 2a extending to the inside of the handle portion 6b and has a substantially L-like shape when viewed from a side thereof as shown in FIG. 1. The battery pack 2 includes release buttons 2b on its two side surfaces. When the battery pack 2 is moved downward while pressing the release buttons 2b, the pack 2 can be removed from the battery hold portion 6c.

In front of the motor 3, there is disposed a cooling fan 18 which is mounted on the rotation shaft 4 and can be rotated synchronously with the motor 3. The cooling fan 18 is a centrifugal fan which, regardless of a rotation direction, can suck the air near the rotation shaft 4 and discharge it outward in a radial direction, whereby the air is sucked from an air suction opening 13a formed rear to the body portion 6a. The air sucked into the housing 6, after passing between the rotor 3a and stator 3b of the motor 3 as well as between the magnetic poles of the stator 3b, reaches the cooling fan 18 and is discharged to the outside of the housing 6 from a plurality of air discharge openings (to be discussed later) formed near an outer peripheral side of the cooling fan 18 in the radial-direction.

The striking mechanism 50 is configured of two parts, namely, an anvil 61 and a planetary carrier assembly 51. The planetary carrier assembly 51 connects together rotation shafts of planetary gears of a planetary gear reduction mechanism 20 and has the function of a hammer (to be discussed later) for striking the anvil 61. Differently from a related-art striking mechanism which is currently widely used, the striking mechanism 50 does not have a cam mechanism including a spindle, a spring, a cam groove, a ball and the like. The anvil 61 and the planetary carrier assembly 51 are connected together through an engagement shaft and an engagement hole formed near the center of rotation in such a manner that only the relative rotation of less than half rotation is possible. The anvil 61 is formed integrally with the output shaft portion for mounting a tip tool (not shown) and includes in its front end a mounting hole 61a. A cross-section of the mounting hole 61a, which is perpendicular to the axial direction, has a hexagonal shape. Alternatively, the anvil 61 and the output shaft for mounting the tip tool may be formed as separate parts and may be connected together thereafter. A rear side of the anvil 61 is connected to the engagement shaft of the planetary carrier assembly 51 and is rotatably held near in its axial-direction central portion on the hammer case 7 by a metal 16a. The anvil 61 includes in its leading end a sleeve 15 for mounting and removing the tip tool at a single touch. Detailed shapes of the anvil 61 and planetary carrier assembly 51 will be described later.

The hammer case 7 is integrally molded of metal in order to store the striking mechanism 50 and planetary gear reduction mechanism 20 and is mounted on the front inside portion of the housing 6. The hammer case 7 is used to hold the anvil 61 through a bearing mechanism and is fixed while it is wholly covered by the housing 6 configured of right and left divided portions. The hammer case 7 is firmly held on the housing 6, thereby being able to prevent the bearing portion of the anvil 61 from shaking.

When the trigger operation portion 8a is pulled to start the motor 3, the rotation of the motor 3 is reduced by the planetary gear reduction mechanism 20 and the planetary carrier assembly 51 is rotated at a rotation number having a predetermined ratio to the rotation number of the motor 3. When the planetary carrier assembly 51 is rotated, its rotation power is transmitted to the anvil 61 through a hammer (to be discussed later) provided in the planetary carrier assembly 51, thereby causing the anvil 61 to start rotating at the same speed as the planetary carrier assembly 51. When the power to be applied to the anvil 61 is increased due to the reaction force received from the tip tool side, a control unit (to be discussed later) detects an increase in a fastening reaction force and, before the rotation of the motor 3 is stopped and is thereby locked, changes the drive mode of the planetary carrier assembly 51 to drive the hammer intermittently.

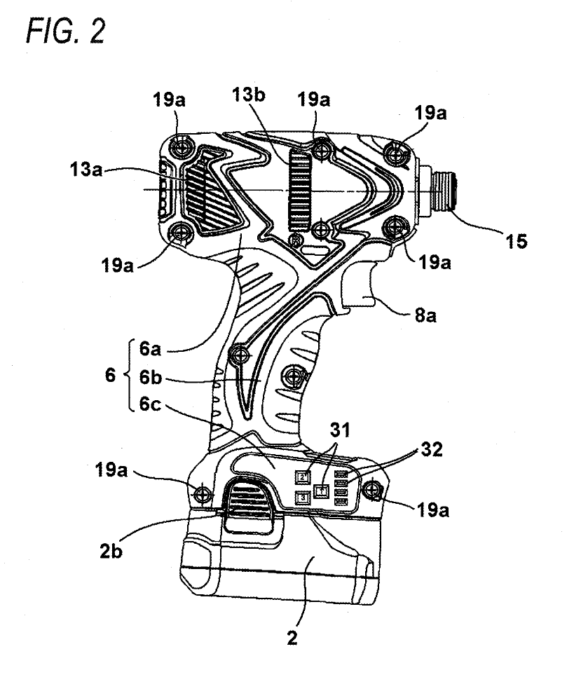

FIG. 2 is a side view of the electric tool 1 of the exemplary embodiment of the invention. The housing 6 is constituted of three portions (a body portion 6a, a handle portion 6b and a battery hold portion 6c), while the body portion 6a has an air discharge opening 13b formed near to the radial-direction outer peripheral side of the cooling fan 18 for discharging the cooling air. The housing 6 is configured of right and left portions divided along its vertical surface passing through the rotation shaft 4 of the motor 3, while the right and left dividable housing 6 is fixed by a plurality of screws 19a. A sleeve 15 constituting the tip tool hold portion projects from the front side of the housing 6. The housing 6 includes, on a portion of the battery hold portion 6c, mode switching switches 31 for switching the drive modes (drill mode, impact mode) of the motor 3 and mode display LEDs 32.

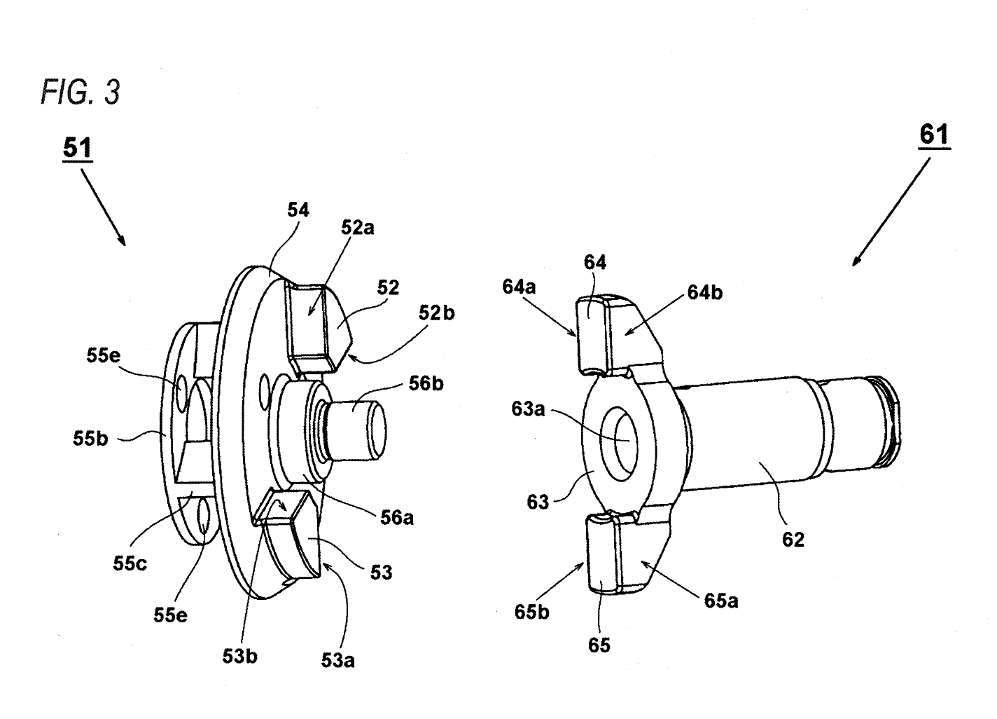

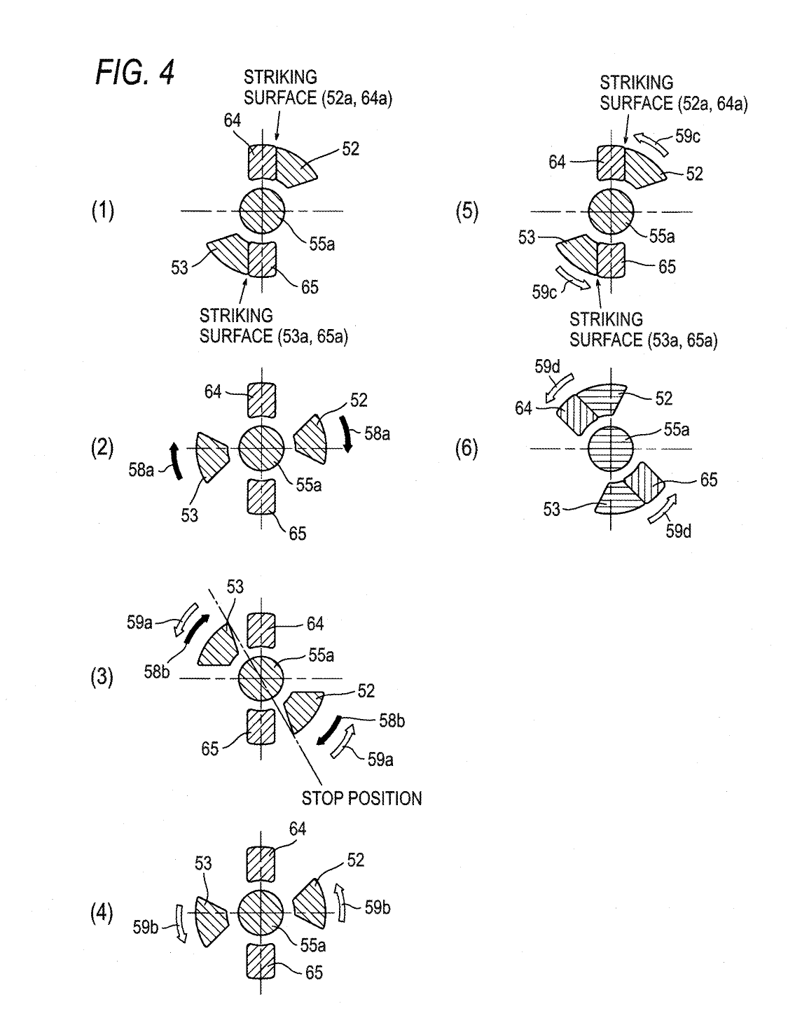

Next, using FIGS. 3 and 4, detailed structures of the planetary carrier assembly 51 and anvil 61 constituting the striking mechanism 50 will be described. FIG. 3 is a perspective view of the planetary carrier assembly 51 and anvil 61, while the planetary carrier assembly 51 is viewed from obliquely ahead and the anvil 61 is viewed from obliquely behind. The planetary gear reduction mechanism 20 of this exemplary embodiment is of a planetary integrated type and includes a sun gear, a plurality of planetary gears and a ring gear. The planetary carrier assembly 51 includes two hammers 52, 53 serving as striking pawls which correspond to the striking pawls 64, 65 of the anvil 61. The planetary carrier assembly 51 rotates in the same direction as the motor 3.

The planetary carrier assembly 51 includes an integrally structured disk-shaped member 54 as the main part thereof, while the disk-shaped member 54 includes two hammers 52, 53 provided on the two opposed portions thereof and projecting therefrom forwardly in the axial direction. The hammers 52, 53 function as striking portions (striking pawls). The hammer 52 includes striking surfaces 52a and 52b in the circumferential direction, while the hammer 53 includes striking surfaces 53a and 53b in the circumferential direction. The striking surfaces 52a, 52b, 53a and 53b are respectively formed as a plane surface and can be properly surface contacted with the struck surfaces (to be discussed later) of the anvil 61. The disk-shaped member 54 includes a butting portion 56a and an engagement shaft 56b respectively disposed forwardly of near the center axis thereof.

The disk-shaped member 54 includes on the rear side thereof two disk portions 55b (only one can be seen in FIG. 3) each having the function of a planetary carrier, while the disk portion 55b include three connecting portions 55c respectively formed in the circumferential-direction three portions for connecting together the two disk portions. Each disk portion 55b includes three penetration holes 55e respectively formed in the circumferential-direction three portions. When three planetary gears (not shown) are interposed between the two disk portions, needle pins (not shown) serving as the rotation shafts of the planetary gears are mounted into the penetration holes 55e. Here, from the viewpoint of strength and weight, preferably, the planetary carrier assembly 51 may be integrally made of metal. Similarly, preferably, the anvil 61 may also be integrally made of metal from the viewpoint of strength and weight.

The anvil 61 includes a disk portion 63 formed rear to a cylindrical output shaft portion 62 and further includes two striking pawls 64, 65 projecting in the outer peripheral direction of the disk portion 63. The striking pawl 64 includes struck surfaces 64a, 64b existing on both sides in the circumferential direction. Similarly, the striking pawl 65 includes struck surfaces 65a, 65b on both sides in the circumferential direction. The disk portion 63 includes an engagement hole 63a formed in the central portion thereof. When the engagement shaft 56b is rotatably engaged into the engagement hole 63a, the planetary carrier assembly 51 and anvil 61 can rotate relative to each other on an extension coaxial with the rotation shaft 4 of the motor 3.

When the planetary carrier assembly 51 rotates in a forward direction (a rotation direction to fasten a screw or the like), the striking surface 52a contacts with the struck surface 64a and the striking surface 53a contacts with the struck surface 65a. When the assembly 51 rotates in a reverse direction (a direction to loosen the screw or the like), the striking surface 52b contacts with the struck surface 65b and the striking surface 53b contacts with the struck surface 64b. Since the shapes of the hammers 52, 53 and striking pawls 64, 65 are determined such that the contact timings coincide with each other, the striking operations are executed in two symmetric portions with the rotation axis as the reference, the assembly 51 balances well in the striking operation, whereby the electric tool 1 is hard to swing.

FIG. 4 is a section view of the hammers 52, 53 and striking pawls 64, 65 when they are used, in which the movement of one rotation is shown in six stages. This section is a surface perpendicular to the axial direction and is taken along the A-A portion of FIG. 1. In FIG. 4, the hammers 52, 53 and disk portion 55a are portions (drive side portions) that rotate together integrally, while the striking pawls 64, 65 are portions (driven side portions) that rotate together integrally. In the state of FIG. 4(1), while a fastening torque from the tip tool is small, the striking pawls 64, 65 are pressed by the hammers 52, 53 and are thereby rotated counterclockwise. However, when the fastening torque increases to thereby disable the striking pawls 64, 65 to rotate only by the pressing forces of the hammers 52, 53, the reverse rotation drive of the motor 3 is started in order to rotate the hammers 52, 53 reversely. The reverse rotation of the motor 3 is started in the state shown in FIG. 4(1), whereby the hammers 52, 53 are rotated in the arrow 58a direction as shown in FIG. 4(2).

When the motor 3 reaches a position where it retreats by a predetermined rotation angle shown by the arrow 58b in FIG. 4(3), a forward rotation direction drive current is allowed to flow in the motor 3 to thereby start the rotation of the hammers 52, 53 in the arrow 59a direction (forward rotation direction). Here, it is important that, when the hammers 52, 53 are rotated reversely, in order to prevent the collision between the hammer 52 and striking pawls 65 and between the hammer 53 and striking pawls 64, the hammers 52, 53 should be stopped positively at their stop positions. What degree the stop positions of the hammers 52, 53 are set before the positions where they collide with the striking pawls 64, 65 may be arbitrary. However, when the fastening torque required is large, it is preferred to increase the reverse rotation angle. The stop positions are detected and controlled using the output signal of the rotation position detecting element of the motor 3.

As shown in FIG. 4(4), when the hammers 52, 53 are accelerated in the arrow 59b direction and the supply of a drive voltage to the motor 3 is stopped at a position shown in FIG. 4(5), almost simultaneously, the striking surface 52a of the hammer 52 collides with the struck surface 64a of the striking pawl 64. Simultaneously, the striking surface 53a of the hammer 53 collides with the struck surface 65a of the striking pawl 65. As the result of this collision, a strong rotation torque is transmitted to the striking pawls 64, 65, whereby they are rotated in a direction shown by the arrow 59d in FIG. 4(6). The position shown in FIG. 4(6) provides a state where the hammers 52, 53 and striking pawls 64, 65 have been both rotated by a predetermined angle from the state shown in FIG. 4(1). By repeating the forward and reverse rotation operations ranging from the state of FIG. 4(1) to FIG. 4(5) again, a member to be fastened (fastened member) is fastened until a proper torque is obtained.

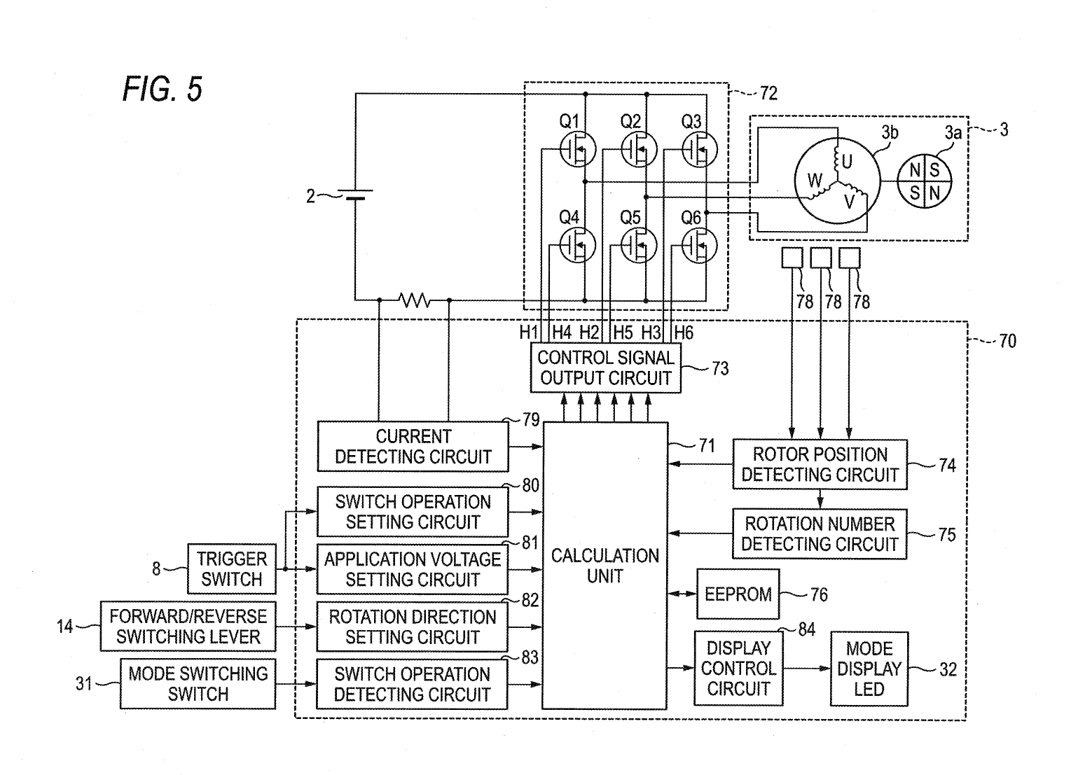

Next, the structure and operation of the drive control system of the motor 3 will be described with reference to FIG. 5. FIG. 5 is a block diagram of the structure of the drive control system of the motor 3. in this exemplary embodiment, the motor 3 is constituted of a 3-phase brushless DC motor. This brushless DC motor, which is of a so called inner rotor type, includes a rotor 3a containing a permanent magnet (magnet) including a plurality of sets (in this exemplary embodiment, two sets) of N and S poles, a stator 3b constituted of star-connected 3-phase stator windings U, V, W, and three rotation position detecting elements (Hall elements) 78 disposed at predetermined intervals in the peripheral direction for detecting the rotation position of the rotor 3a. According to position detecting signals from these rotation position detecting elements 78, the direction and time of conduction to the stator windings U, V, W are controlled and the motor 3 is rotated.

An inverter circuit 72 mounted on the inverter board 10 includes six 3-phase bridge-connected switching elements Q1 to Q6 (switching elements 11 shown in FIG. 1) such as FETs. The gates of the six bridge-connected switching elements Q1 to Q6 are connected to a control signal output circuit 73 mounted on the control circuit board 9, while the drains and sources of the six bridge-connected switching elements Q1 to Q6 are connected to the star-connected stator windings U, V, W. Thus, the six bridge-connected switching elements Q1 to Q6 execute a switching operation according to switching element drive signals (drive signals such as H4, H5 and H6) input from the control signal output circuit 73, whereby power is supplied to the stator windings U, V, W while the DC voltage of the battery pack 2 to be applied to the inverter circuit 72 are switched to 3-phase (U phase, V phase and W phase) voltages Vu, Vv and Vw.

Three switching element drive signals (3-phase signals) for driving the gates of the three negative power supply side switching elements Q4, Q5 and Q6 of the six switching elements Q1 to Q6 are supplied as pulse width modulation signals (PWM signals) H4, H5 and H6 and, using an calculation unit 71 mounted on the control circuit board 9, the pulse widths (duty ratios) of the PWM signals are varied according to a detection signal expressing the detected operation quantity (stroke) of the trigger operation portion 8a of the trigger switch 8 to adjust the quantity of power to be supplied to the motor 3, thereby controlling the start/stop and rotation speed of the motor 3.

Here, the PWM signals are supplied to the positive power supply side switching elements Q1 to Q3 or negative power supply side switching elements Q4 to Q6 of the inverter circuit 72 to switch the switching elements Q1 to Q3 or switching elements Q4 to Q6 at high speeds, thereby controlling the power to be supplied from the DC voltage of the battery pack 2 to the stator windings U, V and W. In this exemplary embodiment, since the PWM signals are supplied to the negative power supply side switching elements Q4 to Q6, the power to be supplied to the stator windings U, V and W is adjusted by controlling the pulse widths of the PWM signals, thereby being able to control the rotation speed of the motor 3.

The electric tool 1 includes a forward/reverse switching lever 14 for switching the rotation direction of the motor 3. Thus, a rotation direction setting circuit 82 switches the rotation direction of the motor 3 whenever it detects the switching of the forward/reverse switching lever 14 and transmits its control signal to the calculation unit 71. The calculation unit 71 includes a central processing unit (CPU) for outputting a drive signal according to a processing program and control data, a ROM for storing the processing program and control data, a RAM for storing the control data temporarily, a timer and so on, although they are not shown in the drawings.

The control signal output circuit 73, according to the output signals of the rotation direction setting circuit 82 and rotor position detecting circuit 74, creates a drive signal for switching the specified ones of the switching elements Q1 to Q6 alternately and outputs the drive signal to the switching elements Q1 to Q6. Accordingly, the specified ones of the stator windings U, V and W are put into conduction alternately to rotate the rotor 3a in the set rotation direction. In this case, a drive signal to be applied to the negative power supply side switching elements Q4 to Q6 is output as a PWM modulation signal according to the output control signal of an application voltage setting circuit 81. The value of the current to be supplied to the motor 3 is measured by a current detecting circuit 79 and the value is fed back to the calculation unit 71, where it is adjusted to provide the set drive power. Here, the PWM signal may also be applied to the positive power supply side switching elements Q1 to Q3.

While the calculation unit 71 includes the RAM for storing the data temporarily, as a nonvolatile external memory, EEPROM (Electrically Erasable Programmable Read-Only Memory) 76 is connected to the calculation unit 71 as a non-volatile external memory. EEPROM 76 can store a plurality of programs to be executed in the calculation unit 71, various parameters and so on. Under the leaning control of this exemplary embodiment, the optimum program to be executed can be selected or various parameters and so on can be changed. The calculation unit 71 includes a display control circuit 84 for controlling the display of a mode display LED 32, whereby a control mode selected by an operator can be displayed by turning on any one of four mode display LEDs 84. Also, to blink the plurality of mode display LEDs 32 can show that a sampling mode is being executed. The control of the turn-on of the mode display LEDs 32 is executed by the display control circuit 84 according to an instruction from the calculation unit 71.

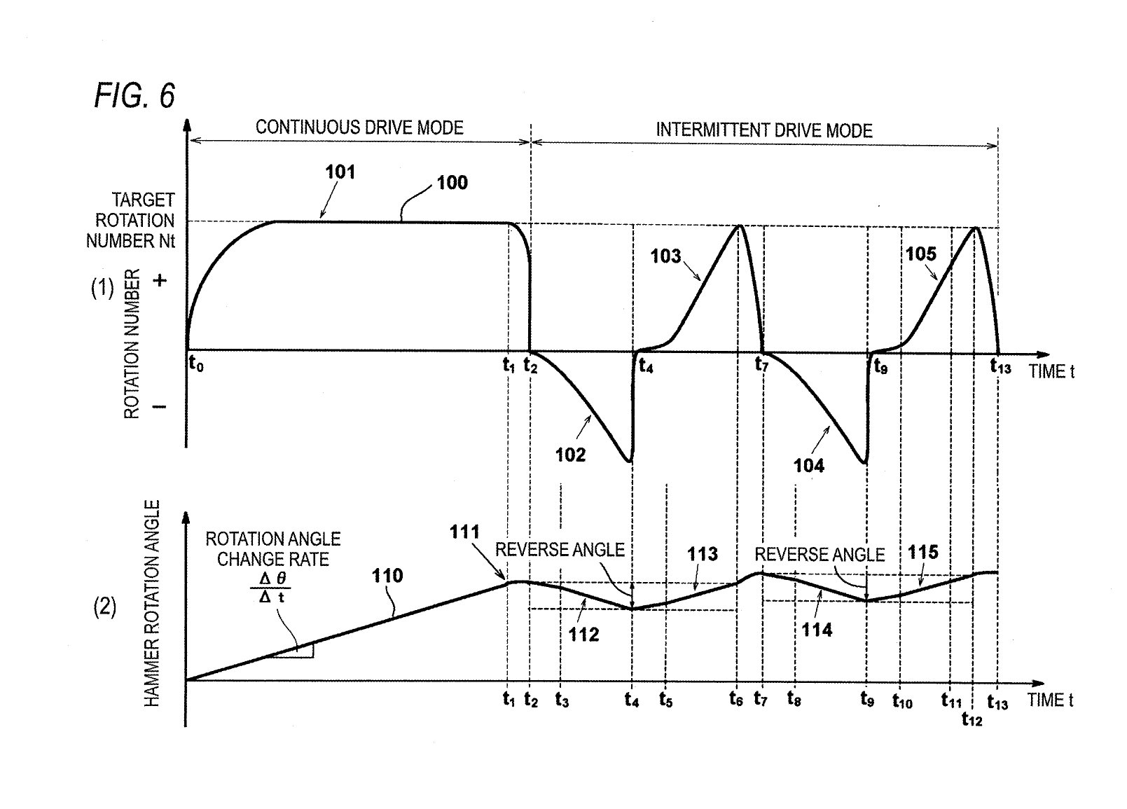

Next, a method for driving the electric tool 1 of this exemplary embodiment will be described by using FIG. 6. FIG. 6 shows the states of the motor rotation number, PWM control duty, striking torque, hammer rotation angle and motor current when executing the drive control of the motor 3. The horizontal axes of the graphs of FIGS. 6(1) and (2) respectively express the passage time t (seconds), while the scales of the horizontal axes of both graphs are matched to each other. In the electric tool 1 of this exemplary embodiment, the anvil 61 and hammers 52, 53 are relatively rotatable at a rotation angle less than 180°. Therefore, the hammers 52, 53 cannot rotate relative to the anvil 61 half rotation or more. This makes the rotation control specific. Specifically, the rotation control includes a “continuous drive mode” for rotating the planetary carrier assembly 51 at the same speed as the anvil 61 and an “intermittent drive mode” for repeating their mutual detaching/attaching and striking operations without rotating at the same speed.

In a fastening operation when an “impact mode” is selected as the operation mode of the electric tool 1, the fastening operation is executed at high speeds in the “continuous drive mode” in the section of time t₀ to t₂ in FIG. 6(1) and, when a required fastening torque value increases, in the section of time t₂ to t₁₃, the operation mode is switched to the “intermittent drive mode” and the fastening operation is executed. In the continuous drive mode, the calculation unit 71 controls the motor 3 according to the target rotation number. Thus, the motor 3 is accelerated until its rotation number reaches the target rotation number Nt, and the anvil 61 rotates integrally with the hammers 52, 53 while being pressed by them. After then, at the time t₁, when a fastening reaction force from a tip tool mounted on the anvil 61 increases, a reaction force from the anvil 61 to the hammers 52, 53 increases, whereby the rotation speed of the motor 3 reduces gradually. On detecting the reduced rotation speed of the motor 3, at the time t₂, the calculation unit 71 starts to drive the motor 3 to rotate reversely using the intermittent drive mode.

The intermittent drive mode is a mode to drive the motor 3 intermittently without driving it continuously, in which the motor 3 is driven in a pulsing manner such that “reverse rotation drive and forward rotation drive” is repeated a plurality of times. Here, “to drive the motor in a pulsing manner” in this specification means that, by pulsing a gate signal to be applied to the inverter circuit 72, a drive current to be supplied to the motor 3 is pulsed to thereby pulse the rotation number or output torque of the motor 3. The cycle of pulsing is, for example, about dozens of Hz to a hundred and dozens of Hz. When switching the forward rotation drive and reverse rotation drive, a rest time may be interposed between them, or they may be switched with no rest time. Here, although the PWM control is executed for the rotation number control of the motor 3 in the drive current on state, the pulsing cycle is sufficiently small when compared with the cycle (normally, several KHz) of the duty ratio control thereof.

FIG. 6(1) is a graph of the rotation number 100 of the motor 3, wherein + expresses the forward rotation direction (the same direction as the rotation direction as intended) and − the reverse rotation direction (the opposite direction to the rotation direction as intended). The vertical axis expresses the rotation number (unit: rpm) of the motor 3. When, the trigger operation portion 8a is pulled and the motor 3 is thereby started at the time t₀, the motor 3 is accelerated until the rotation number reaches the target rotation number Nt and, as shown by an arrow 101, the motor 3 is controlled to rotate constantly at the target rotation number Nt.

After then, a bolt or the like serving as a target to be fastened is seated, the rate of change of the rotation angle of the hammers 52, 53 reduces greatly and the rotation of the motor 3 gradually reduces from the time t₁. On detecting that the rotation angle change rate goes below a predetermined threshold value during the time t₁ to t₂, the calculation unit 71 stops the supply of the forward rotation drive voltage to the motor 3, whereby the motor 3 is switched to the rotation control in the “intermittent drive mode”. At the time t₂, the supply of the reverse rotation drive voltage to the motor 3 is started. The supply of the reverse rotation drive voltage is carried out by the calculation unit 71 (see FIG. 5) transmitting a negative direction drive signal to the control signal output circuit 73 (see FIG. 5). To switch the motor 3 between the forward and reverse rotations can be realized by switching the signal patterns of the respective drive signals (ON/OFF signals) to be output from the control signal output circuit 73 to the switching elements Q1 to Q6. Here, in the rotation drive of the motor 3 using the inverter circuit 72, the application voltage is not switched from plus to minus but only the sequence of supply of the drive voltages to the coils is changed.

The supply of the reverse rotation drive voltage causes the motor 3 to start to rotate reversely, whereby the hammers 52, 53 also start to rotate reversely (arrow 102). In this reverse rotation time, the hammers 52, 53 move in a direction to part away from the striking pawls 64, 65 and thus rotate under no load. Therefore, the hammers 52, 53 rotate greatly reversely. After then, while repeating the forward and reverse rotations, the striking operations are carried out. Here, the time t₂ to t₄ shown by the arrow 102 and the time t₇ to t₉ shown by the arrow 104 are for the reverse rotation drive of the motor 3, while the time t₄ to t₇ shown by the arrow 103 and the time t₉ to t₁₇ shown by the arrow 105 are for the forward rotation drive.

FIG. 6(2) is a graph of the rotation angle of the hammers 52, 53, that is, the rotation angle 110 of the planetary carrier assembly 51. The vertical axis expresses the rotation angle of the hammers 52, 53 (unit: rad). The calculation unit 71 obtains cyclically the change rate of the rotation angle (=Δθ/Δt) of the hammers 52, 53 rotating in the “continuous drive mode” and monitors the change rate. Since the rotor position detecting circuit 74 outputs detection pulses at every predetermined intervals to the calculation unit 71 according to the output signal of the rotation position detecting element 78, by monitoring the number of the detection pulses, the calculation unit 71 can calculate the change rate of the rotation angle of the hammers 52, 53. In this exemplary embodiment, since three rotation position detecting elements 78 such as Hall ICs are provided at the intervals of 60° in terms of rotation angle, the detection pulses to be output from the position detecting circuit 74 are output every 60° of rotation angle. Also, since the rotation of the rotor 3a is reduced at a predetermined reduction ratio (in this exemplary embodiment, 1:8) by the planetary gear reduction mechanism 20, the detection pulses of the rotation position detecting element 78 are output every 7.5° of the rotation angle of the hammers 52, 53. Therefore, by counting the number of detection pulses output from the position detecting circuit 74, the calculation unit 71 can detect the rotation angle of the hammers 52, 53 relative to the anvil 61.

In the continuous drive mode from the time t₀ to t₁, since the rotation number of the motor 3 is almost constant, the rotation angle change rate Δθ/Δt is almost constant. During the time t₂ to t₄, the motor 3 is rotated reversely as shown by an arrow 112. At the time t₄, when the reduction quantity of the rotation angle of the hammers 52, 53 reaches a predetermined reverse rotation angle, the supply of the forward rotation drive voltage to the motor 3 is started. The forward rotation drive voltage causes the motor 3 to start its forward rotation, whereby the hammers 52, 53 also start their forward rotation. In this forward rotation time, the hammers 52, 53 move in the direction to approach again the striking pawls 64, 65 of the anvil 61 and thus move with no load, thereby increasing the rotation angle of the hammers 52, 53 greatly.

Next, at the time t₆, when the increasing quantity of the rotation angle of the hammers 52, 53 reaches a predetermined reverse rotation angle, the supply of the forward rotation drive voltage to the motor 3 is stopped. This stop time is near the time when the rotation speed of the motor 3 reaches the maximum speed. Thus, the hammers 52, 53 collide with the striking pawls 64, 65 heavily, thereby generating a large striking torque. By repeating the supply of the reverse rotation drive voltage to the motor 3 (arrow 114), the supply of the forward rotation drive voltage (arrow 115) and the stop of supply of the drive voltage to the motor 3 (time t₁₂ to t₁₃) in this manner, the impact operation is executed to complete the fastening of a fastening member such as a bolt. The end of the fastening operation is carried out by an operator releasing the trigger operation portion 8a at the time t₁₃. Here, instead of releasing the trigger operation portion 8a, the end of the operation may also be executed by additionally providing a known sensor (not shown) for detecting the value of a fastening torque provided by the anvil 61, and when the fastening torque value detected reaches a predetermined value, the calculation unit 71 may forcibly stop the supply of the drive voltage to the motor 3.

As described above, in the electric tool 1, by realizing the rotation drive in the continuous drive mode and the intermittent drive in the intermittent drive mode (impact operation) under the control of the calculation unit 71, a screw, a bolt and the like can be fastened. This control can realize various control states and control modes depending on various setting conditions, for example, the setting of the rotation angle of the motor, the setting of the timing for switching the continuous drive mode to the intermittent drive mode, the setting of the reverse angle, and the quantity of supply of the current to the motor under various conditions.

In this exemplary embodiment, the control method by the calculation unit 71 can be changed according to a use state of an operator. For example, in an impact tool, a content of learning considered as prerequisite conditions for this change include the optimum rotation number, management torque value, number of striking actions, etc. In a driver with a clutch function, the content of learning is the fastening torque values necessary when a clutch mechanism operates. In this manner, appropriate control for operations to be executed by different operators can be realized due to the learning function. In this exemplary embodiment, a fastening operation serving as a reference is executed several times on a specific portion to obtain various data such as the fastening time, motor current, variations in the rotation number and the number of times of striking operations, while control information is created using the obtained data and is stored into EEPROM 76 (see FIG. 5). After end of the learning operation, the control of the electric tool is executed using the control information stored in EEPROM 76.

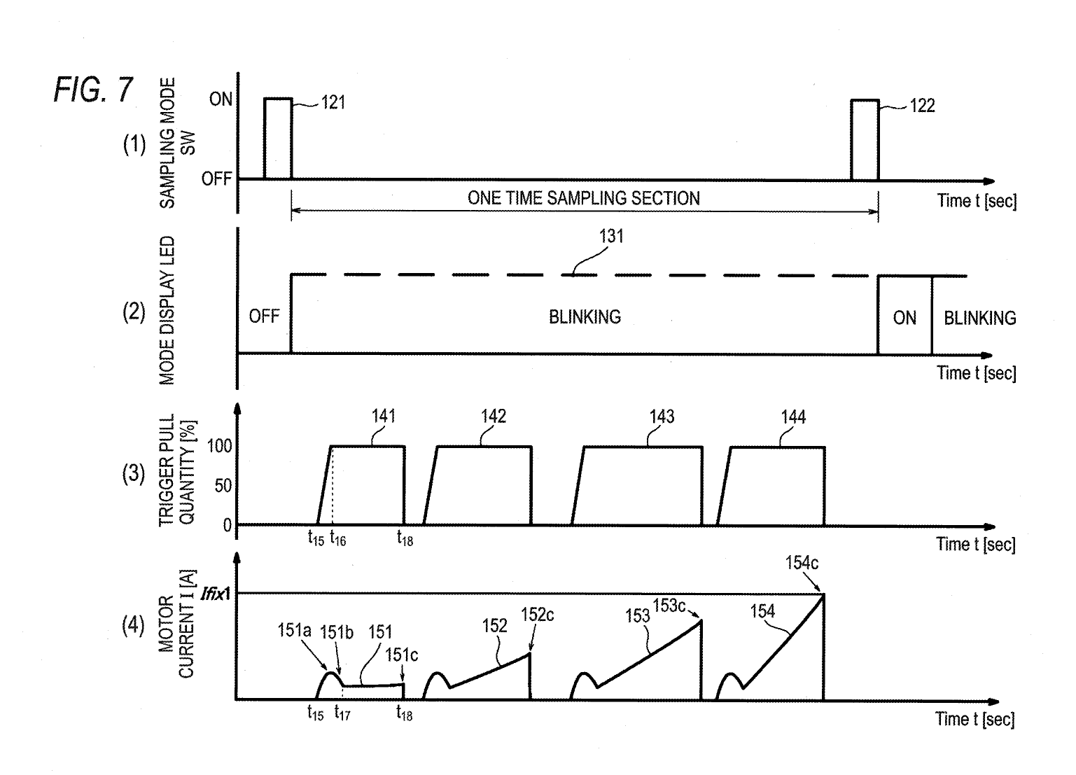

FIG. 7 shows the states of the respective parts during the learning operation time according to the exemplary embodiment of the invention. The horizontal axes (time t) of the respective graphs shown in (1) to (4) are matched to the same scale. In FIG. 7, the electric tool 1 is set in a learning operation mode (sampling mode), the operation of the electric tool serving as a sample is executed a plurality of times in the learning operation mode, the working conditions of the electric tool in the sampling operation mode are obtained, and they are reflected to a normal operation after end of the learning operation.

Firstly, as shown in FIG. 7(1), a predetermined switch for setting the electric tool in the sampling mode is operated. In this case, an exclusive-use switch for setting the sampling mode may be provided. However, preferably, the sampling mode may be set, for example, by pressing a plurality of buttons the mode switching switch 31 (see FIG. 2) for a certain while. The reason for use of the plurality of buttons is, since the sampling mode is not set frequently, the wrong operation can be prevented as much as possible by making the sampling mode setting operation to differ from the normal operation. Also, to press the buttons for a certain while can prevent the normal operation from being switched easily to the sampling mode during execution of the normal operation. When the plurality of the buttons of the mode switching switch 31 are pressed for a certain while simultaneously, an ON signal 121 for the sampling mode is transmitted from the switch operation detecting circuit 83 (see FIG. 5) to the calculation unit 71. On receiving this signal, the calculation unit 71 executes the control of the “sampling mode” to be discussed later. One sampling mode continues until an ON signal 122 is transmitted from the switch operation detecting circuit 83 to the calculation unit 71 when the plurality of buttons of the mode switching switches 31 are pressed for a certain while again. During this sampling mode, one or all of the mode display LEDs 32 are caused to blink to thereby express that the current operation is not a normal operation but a learning operation during the sampling mode (arrow 131 in FIG. 7(2)).

The operator of the electric tool actually executes an operation desired to be learned during this sampling mode. FIG. 7(3) shows a state where a fastening operation has been actually executed four times (fastening operations 141 to 144) using the impact driver shown in FIG. 1. In this case, a learning operation for determining the timing for switching the continuous drive mode to the intermittent drive mode is executed in the actual operation in the continuous drive mode, and especially, an operation to fasten a fastening member such as a screw or a bolt to a member to be fastened is executed. In the fastening operation 141, at time t₁, the operator pulls the trigger operation portion 8a to start the motor 3, increases the pull quantity of the trigger operation portion 8a up to 100% until time t₁₆ comes and releases the trigger operation portion 8a at an arbitrary fastening depth where the mode is to be switched to the intermittent drive mode. FIG. 7(3) shows a state where the operator has released the trigger operation portion 8a at time t₁₈. The motor current to be detected by the current detecting circuit 79 (see FIG. 5) at this time is a current value 151 shown in FIG. 7(4).

The current value 151 rises at time t₁₅ and, because it is the starting current of the motor 3, becomes largest in the portion of an arrow 151a. After then, while the influence of the starting current reduces, the current value 151 lowers like an arrow 151b and, at and from time t₁₇, becomes a current value in the steady state rotation time. In the continuous drive mode, since the hammer does not strike the anvil, in order to provide a predetermined high torque value, the operator must hold the electric tool 1 firmly by hand. While bearing a reaction force given from the fastening member, the operator executes the fastening operation and, when the torque seems to have reached the target torque, or when the operator cannot bear the reaction force by hand (arrow 151c, time t₁₈), the operator releases the trigger operation portion 8a to thereby stop the rotation of the motor 3. Here, although the operations 142, 143 and 144 are the repeated versions of the same operation, they show states where, while bearing a stronger reaction force, the operator has rotated the motor up to the state of the assumed optimum torque value. In the example shown in FIG. 7, the motor currents I in the ends of the respective fastening operations increase like 152c, 153c and 154c in FIG. 7(4), and the current value 154 of the operation 144 increases up to I_{fix1} finally. On determining that the sampling operation in a state to be learned has ended, the operator presses the plurality of buttons of the mode switching switches 31 for a certain while again to end the first time sampling operation.

In this manner, through the learning operation during the sampling mode, various motor currents I can be obtained. In this exemplary embodiment, for example, there is used the motor maximum current I_{fix1}. The following operations of the electric tool are executed using this maximum current I_{fix1}. However, there is a fear that the maximum current I_{fix1} cannot be obtained correctly only in one (one set of) learning operation. Thus, a series of operations shown in FIG. 7 are executed a plurality of times, for example, three times to obtain the maximum current I_{fix1}, the maximum current I_{fix2}, and the maximum current I_{fix3} and they are averaged to obtain I_{fix}. Accordingly, in this exemplary embodiment, following the ON signal 122 in the sampling mode, a second sampling period starts. Similarly, after the end of a third sampling period, when the plurality of buttons of the mode switching switches 31 are pressed for a certain while, the sampling mode is ended and the mode is returned to the normal operation mode of the electric tool 1. Here, in this exemplary embodiment, the sampling period is set to continue three times. However, it is not limited to three times but an arbitrary number of times may be set, or it may be specified arbitrarily by the operator.

Here, in FIG. 7, the operator executes the fastening operation in the continuous drive mode and when the operator judges that the fastening operation is ended, the user releases the trigger operation portion 8a. However, a torque measuring device may be mounted and, while measuring a torque value actually using the torque measuring device, the operator may execute the fastening operation.

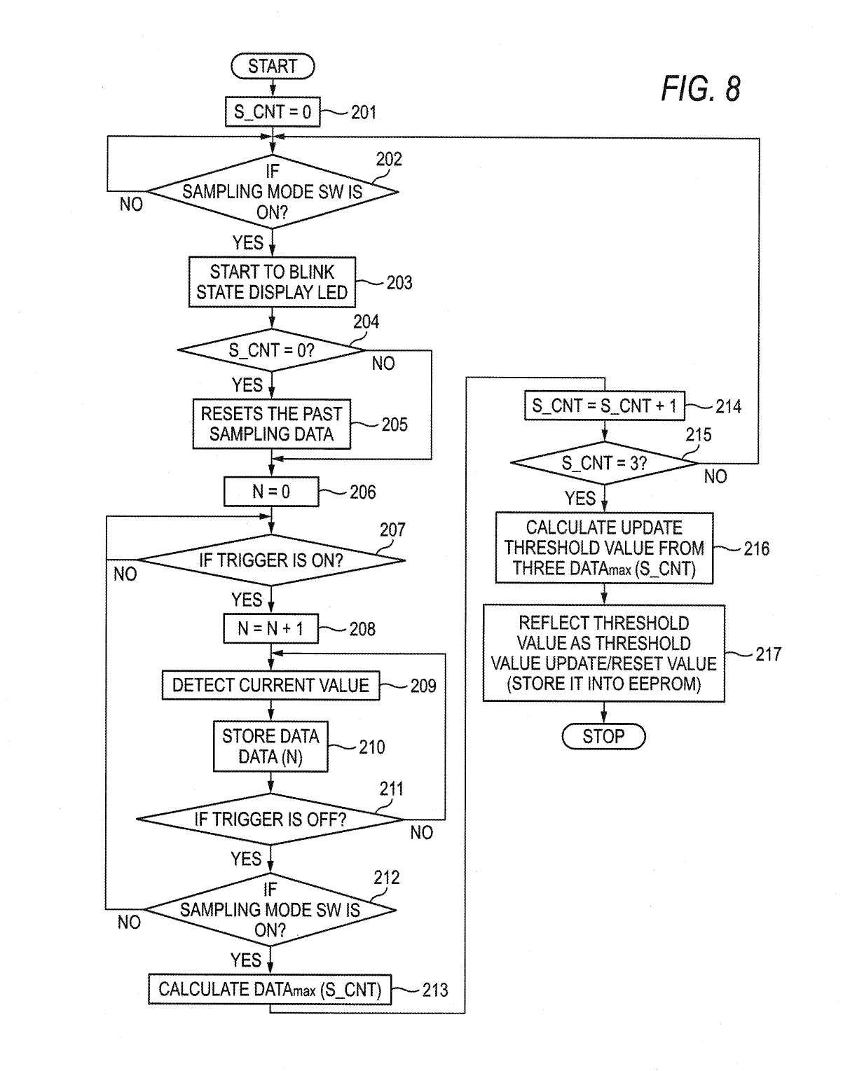

Next, a learning procedure to be taken by the calculation unit 71 will be described by using a flow chart shown in FIG. 8. The learning procedure shown in this flow chart can be realized in the form of software when programs are executed by a microcomputer (not shown) incorporated in the calculation unit 71.

Firstly, when the battery pack 2 is mounted into the electric tool 1, various data stored in a volatile memory within the electric tool 1 are initialized and the calculation unit 71 zero clears the count value S_CNT of the sampling operation (Step 201). Switching to a sampling mode is executed by pressing a sampling SW (switch) and the calculation unit 71 checks whether the sampling SW is pressed or not (Step 202). Here, for example, to press the plurality of mode switching switches 31 for a certain while simultaneously can be defined as the sampling SW and use of the mode switching switches 31 in this way eliminates the need to provide the sampling SW separately. When the sampling SW is pressed, the mode display LED 32 starts to blink (Step 203). By blinking the mode display LED 32, the operator can easily know that the current mode is a sampling mode different from a normal operation mode. Next, the calculation unit 71 checks whether the count value S_CNT of the sampling operation is zero or not (Step 204) and, when zero, resets the past sampling data (205). When it is not zero, the calculation unit 71 goes to Step 206.

Next, a counter N for counting the number of times of execution of a procedure ranging from Step 207 to Step 212 is cleared to zero (Step 206). Then, the calculation unit 71 detects whether the operator has pulled the trigger operation portion 8a and has turned the trigger switch 8 on or not. When it is OFF, the calculation unit 71 waits until it is turned ON (Step 207). When the trigger operation portion 8a is pulled and the trigger switch 8 is turned on, the counter N is counted up by 1 (Steps 207, 208), and the calculation unit 71 detects the value of a current flowing in the motor 3 from the output value of the current detecting circuit 79 (Step 209). Next, the calculation unit 71 temporarily stores the obtained current data into a predetermined portion of a memory area as DATA (N). Since the operation to detect the current value and store the current data into a predetermined portion of a memory area as DATA (N) is repeated until the trigger operation 8a is turned off (Steps 209 to 211), when the trigger operation 8a is turned off, current values (normally, these current values provide the maximum current) at positions shown by the arrows 151c, 152c, 153c and 154c in FIG. 7 are respectively stored into DATA (N) as obtained data.

Next, the calculation unit 71 detects whether a first time sampling operation is ended or not by pressing the sampling SW (switch) again (Step 212). When not ended in Step 212, the calculation unit 71 returns to Step 207 and repeats Steps 207 to 211. When the sampling operation is ended in Step 212, the maximum value is selected from the obtained data stored in DATA (N) and is defined as DATAmax (S_CNT). Next, the calculation unit 71 increments S_CNT to increase by 1 (Step 214) and checks whether S_CNT becomes 3 or not (Step 215). When not in Step 215, the calculation unit 71 returns to Step 202 and repeats the processings in Steps 202 to 214.

Next, using the DATAmax (0), DATAmax (1) and DATAmax (2) obtained in the three-time processings, the calculation unit 71 updates a threshold value to be used for controlling the electric tool 1 (Step 216). There are available various methods as to how to calculate the data to be updated. In this exemplary embodiment, using the average value of the data, the calculated average current value is updated as the current threshold value I_{TH} of the motor 3 when the continuous drive mode of the impact tool is switched to the intermittent drive mode. Next, the calculation unit 71 stores the threshold value into EEPROM 76 (see FIG. 5) and thus reflects it as the re-set value, and then the calculation unit 71 ends the processing (Step 217).

As described above, in this exemplary embodiment, the sampling mode is set to the electric tool and, in the sampling mode, the use state where the operator has operated the electric tool is learned and, according to the data learned, the respective threshold values and parameters for control can be changed. Also, since the threshold values and parameters are stored in EEPROM 76 and are thereafter used for control, when executing a specific fastening operation, the operator enables the electric tool to learn the use state to be desired by the operator and thus the optimum operation condition can be set.

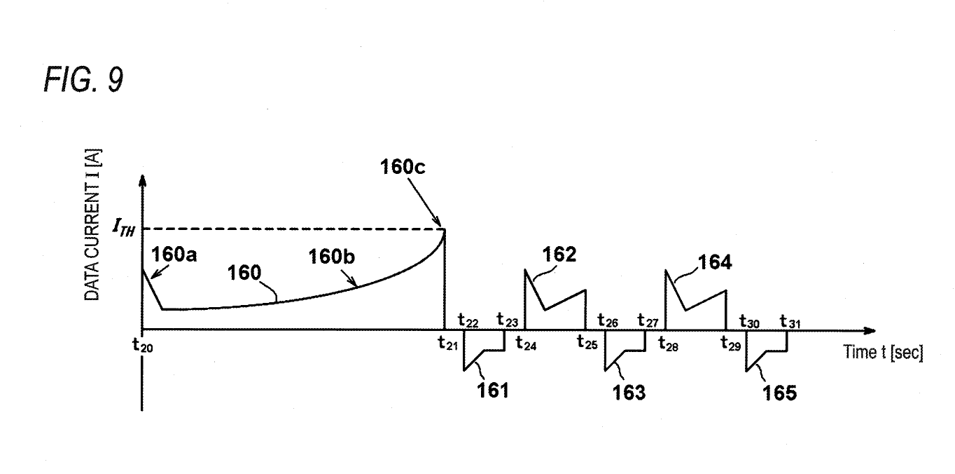

FIG. 9 shows the control for switching the continuous drive mode to the intermittent drive mode using the current threshold value I_{TH} of the motor 3 learned in this exemplary embodiment. When the impact mode is selected in the electric tool 1, at time t₂₀, the motor 3 is started in the continuous drive mode. The value of a current flowing in the motor 3 reduces once after a start current shown by an arrow 160a, and thereafter, increases like an arrow 160b, and at time t₂₁, like an arrow 160c, reaches the current threshold value I_{TH} obtained in the sampling mode.

While monitoring the output of the current detecting circuit 79, the calculation unit 71, on detecting that the current value 160 reaches the current threshold value I_{TH}, switches its control from the currently used continuous drive mode to the intermittent drive mode, thereby repeating the drive for rotating the motor reversely and forwardly as described in FIG. 4. The calculation unit 71, after cutting the supply of the current to the motor 3 once at time t₂₁, supplies a reverse rotation current 161 from time t₂₂ to time t₂₃ to thereby reverse the hammers 52, 53 (see FIG. 3) by a predetermined reverse angle. When the hammers 52, 53 (see FIG. 3) are reversely rotated by the predetermined angle, after cutting the supply of the current to the motor 3 once at time t₂₃, the calculation unit 71 supplies the reverse rotation current 161 from time t₂₄ to time t₂₅. Near time t₂₅, the hammers 52, 53 collide with the striking pawls 64, 65 to thereby transmit stronger striking forces to the anvil 61.

While repeating a similar operation to further supply a reverse rotation current 163, a forward rotation current 164 and a reverse rotation current 165 to the motor 3, the calculation unit 171 executes the intermittent drive of the motor 3. Here, in an example shown in FIG. 9, time intervals t₂₁ to t₂₂, t₂₃ to t₂₄, t₂₅ to t₂₆, t₂₇ to t₂₈ and t₂₉ to t₃₀ are set as power supply stop sections during which no current is supplied to the motor 3. This is because, when the current supply to the motor 3 is reversed suddenly, there is a fear that the operation of the motor 3 can be unstable. However, the sizes of the power supply stop time intervals may also be calculated based on the learned current threshold value I_{TH}. Also, other control parameters, for example, the time intervals t₂₂ to t₂₃, t₂₄ to t₂₅, t₂₆ to t₂₇, t₂₈ to t₂₉ and t₃₀ to t₃₁ may also be set by calculating them based on the data obtained in the sampling mode.

In the above-described exemplary embodiment, the data to be obtained in Step 210 is defined as the value of a current flowing in the motor 3. However, the data to be obtained for learning is not limited to the current value of the motor 3 but various kinds of data such as the upper limit value of the rotation number of the motor 3, the limit value (strength and weakness control) of the duty ratio of PWM to the switching element 11 in the striking time, and the number of times of striking operations or striking time of the hammers 52, 53 against the anvil 61 may also be obtained and reflected. In this exemplary embodiment, the use state is not limited to the state set when the electric tool is shipped from a factory but the operator (user) may arbitrarily execute an operation to set a state to be used as the reference and allow the tool to learn the state, thereby realizing an appropriate use state. Therefore, it is possible to realize an electric tool which can carry out drive control most suitable for the using condition of the operator.

While it is important that the control of the electric tool 1 can be set through learning in the sampling mode, it is also important to provide a reset function which can reset the learned state. For example, when the operator wants to cancel the learned contents and return the state of the tool to the initial state in the factory shipping time, the state may be returned to the initial state by the reset operation allocated to a specific switch. In this reset operation time, the state may not be returned to the initial state completely but, by taking a calibration margin such as the aged deterioration of the electric tool main body into account, the state may be set such that a seeming state becomes the same state as in the factory shipping time.

Here, as the parameters that can be learned in the sampling mode and the parameters that can be returned to the initial states using the reset operation, various parameters are available. Meanwhile, it is important that the optimum values of various set values for protecting the main body of the electric tool 1, for example, an overcurrent protection value, an over-temperature protection value, an over-discharge voltage value and a striking cycle, cannot be changed by a learning operation.

Although the invention has been described with reference to its exemplary embodiment, the invention is not limited to the above-described exemplary embodiment but various changes are possible without departing from the subject matter of the invention. For example, in the above exemplary embodiment, description was given to an example using the impact driver. However, the impact driver is not limitative but the invention can be applied to an arbitrary electric tool, provided that it can be controlled by a microcomputer. Also, in the above exemplary embodiment, description was given of the learning of the control threshold value in the switching time from the continuous drive mode to the intermittent drive mode in the impact driver. However, the threshold value to be learned is not limited to this but it may also be the clutch operation threshold value of a driver with an electronic clutch, or arbitrary data or parameters which can be learned by a user operating the electric tool.

Further, a plurality of control programs and control parameters may be previously stored in EEPROM and, using the data obtained in the sampling mode, the optimum control program or parameter may be selected from them. In this case as well, since the learning function can be actuated with a voluntary will of the operator, it is possible to realize an electric tool easy to use.

This application claims priority from Japanese Patent Application No. 2011-159909 filed on Jul. 21, 2011, the entire contents of which are incorporated herein by reference.

### INDUSTRIAL APPLICABILITY

According to an aspect of the invention, there is provided an electric tool which can realize an optimum drive mode for every user.

1. An electric tool comprising:
a motor;
a tip tool configured to be rotationally driven by the motor; and
a control unit configured to control the rotation of the motor and including a microprocessor and a memory unit,
wherein the memory unit is configured to store control information by learning a use state of the motor, and
wherein the motor is configured to be driven according to the stored control information.

2. An electric tool according to claim 1,
wherein the control information includes any one of a fastening time by the motor, a current limit value of the motor and a rotation number of the motor.

3. An electric tool according to claim 2,
wherein the control information is a learning value which is obtained during a specific operation specified by an operator.

4. An electric tool according to claim 1,
wherein the electric tool is a striking tool including a hammer and an anvil, and
wherein the control information is information for determining a timing for shifting from a continuous drive mode to an intermittent drive mode using the hammer and the anvil.

5. An electric tool according to claim 4,
wherein the control information is a current value of the motor when switching the continuous drive mode to the intermittent drive mode.

6. An electric tool according to claim 1, further including a sample mode switch for designating a start and an end of the specific operation.

7. An electric tool according to claim 6,
wherein the specific operation is executed for a plurality of times and a value calculated from a plurality of drive current values, which is obtained during the specific operation, is set as control information.

8. An electric tool according to claim 7,
wherein the calculated value is an average of maximum values of the obtained drive current values.

9. An electric tool according to claim 1, further including a reset function for canceling the control information stored in the memory unit and replacing the control information to control information which is set when the electric tool is shipped from a factory.
